(19) United States
(12) Patent Application Publication
(10) Pub. No.: US 2017/0142993 A1
(43) Pub. Date: May 25, 2017

(54) CREATINE-PROTEIN MATRIX AND METHOD FOR PRODUCING SAID MATRIX

(71) Applicant: ALZCHEM AG, Trostberg (DE)

(72) Inventor: Barbara NEISS, Trostberg (DE)

(73) Assignee: ALZCHEM AG, Trostberg (DE)

(21) Appl. No.: 15/300,348

(22) PCT Filed: Mar. 27, 2015
(86) PCT No.: PCT/EP2015/056762

§ 371 Date: Sep. 29, 2016

(30) Foreign Application Priority Data
Apr. 2, 2014 (EP) 14001230.3

(51) Int. Cl. A23C 21/08; A23L 33/18; A23L 33/19; A23L 33/165

(52) U.S. Cl. CPC A23C 21/08; A23L 33/165; A23L 33/18; A23L 33/19; A23V 2002/00

(57) ABSTRACT

The invention relates to a powdery creatine-protein matrix comprising a protein component and a creatine-component for use as a food supplement for athletes and to a method for producing said creatine protein matrix. Said matrix has an improved solution behaviour compared to powder mixtures with the same composition.

The present invention relates to a creatine protein matrix in powder form and to a method for producing said creatine protein matrix. The creatine protein matrix is suitable in particular for use as a food supplement, in particular for athletes or people who are actively engaged in sport.

Creatine is an endogenous substance which occurs in vertebrates and also in humans and which is formed in the body from guanidinoacetic acid, the direct metabolic precursor of creatine. Creatine plays an important part in the energy metabolism of the cell. In the body, phosphorylation of creatine leads to the formation of phosphocreatine which, in addition to adenosine triphosphate (ATP), represents an important energy reserve of muscle. Creatine can be both formed naturally and absorbed from food, for which reason creatine has long been known as a suitable food supplement. In the case of intensive muscle activity sustained over a prolonged period, the creatine reserves naturally present in the body are quickly exhausted. For this reason, in particular in competitive athletes, purposive creatine administration has had a positive effect on performance.

In addition to creatine, proteins are also a valuable constituent of food for athletes. Proteins can be obtained from animal or plant sources and have different properties and functionalities depending on the source, production method and method of processing. In recent years, whey protein, for example, and refined variants thereof have been found to be a particularly advantageous supplement for food for athletes.

Whey proteins are a constituent of whey, the fraction of milk that remains after acid or rennet precipitation. Apart from the casein fraction, the whey proteins fraction represents the second important protein fraction of the milk of mammals, the total amount of approximately 3.3 wt. % protein in cow's milk comprising, for example, approximately 2.7 wt. % casein and 0.6 wt. % whey proteins. The whey can be processed further by various methods so that whey protein concentrates, isolates and hydrolysates can be obtained, which are very nutritious and easily digestible.

The whey protein of cow's milk itself is composed of the following protein fractions:

| Whey protein | Whey protein fraction | Proportion [%] |
|---|---|---|
| Albumin | Beta-lactoglobulin | ~56 |
| | Alpha-lactalbumin | ~21 |
| | Serum albumin | ~7 |
| Globulin | Lactoferrin | ~2 |
| | Immunoglobulin | ~14 |

These proteins are particularly rich in amino acids and are therefore relevant for muscle formation. Whey proteins belong to the so-called fast acting proteins, that is to say the proteins are digested, i.e. hydrolysed in the digestive tract, quickly. Consequently, the amino acids are also absorbed quickly and are available to the body quickly. For example, when a whey protein concentrate is consumed, the maximum leucine concentration in the blood is reached after only about 60 minutes following ingestion of the protein.

In addition, it has been shown that whey proteins promote the excretion of insulin. In this connection, there are suggestions that the excretion of insulin is facilitated by the high proportion of branched amino acids (leucine, isoleucine, valine).

Creatine passes through the digestive tract similarly quickly to whey proteins, so that both components have a similar digestion profile. In addition, it has been shown for creatine that the absorption of creatine into the muscle can be improved in the presence of an elevated insulin level, and therefore the combination of creatine with an insulinotropic substance improves the utilisation of creatine.

Conventional whey protein concentrates, isolates and hydrolysates contain lactose (up to 5%), which is extremely problematical for persons with a lactose intolerance. Soy protein is often offered as an alternative, but it is less advantageous in terms of taste and as regards digestibility.

Milk naturally already contains creatine, but the contents are very low. They are generally between 50 and 100 mg/kg, that is to say a maximum of 0.01 wt. %. A whey protein concentrate, isolate or hydrolysate produced from this milk likewise still has a natural creatine content, which at the maximum is 0.015 wt. % in dry matter.

On account of the mentioned properties, creatine and whey proteins, in particular whey protein concentrates and isolates, are popular food supplements for athletes. They are often supplied individually in powder form. Moreover, a number of products are known which comprise creatine and whey proteins as well as in some cases numerous further substances as a constituent of complex physical mixtures, so-called blends. On closer examination of such products, it was found that the blends have a tendency to demixing. This can occur during the production of a mixture, but also during filling or transportation of the mixture. Blends consisting of mixtures of particles of different sizes tend to demix in particular, that is to say a homogeneous distribution of the constituents in the mixture is not ensured in the long term.

In addition, it has been shown that creatine as such, but also in such mixtures (blends), dissolves only slowly when water is added. For example, it is possible to observe that, when a physical mixture of creatine and whey protein is added to water, a sediment consisting predominantly of creatine forms. This property can also be observed when the consumer prepares a mixture of the two components himself. This is also disadvantageous when creatine is used as a constituent of a DBB powder mix (dry blend beverage). In both cases, the consumer experiences an unpleasant sandy feeling in the mouth upon consumption, due to the creatine crystals that are present. When such a mixture is used, it is also necessary repeatedly to suspend the product thoroughly in order to ensure complete ingestion of the constituents. Creatine is thereby usually used in the form of its monohydrate, which is crystalline and has a mean particle size of approximately from 100 to 150 μm.

In addition to the products described here and available on the market, many compositions that comprise creatine and proteins are also described in the patent and technical literature. By way of example, mention may be made here of patent documents DE 102005050879 A1, U.S. Pat. No. 5,726,146 A, U.S. Pat. No. 6,521,591 B1, US 2006,0198899 A1, US 20030215506 A1, US 20060062827 A1, US 20010008641 A1 and US 20010041187 A1. It is a common feature of all these applications that they describe only blends or other physical mixtures which are present in aqueous or gel-like form or which tend to demix owing to their formulation.

Furthermore, U.S. Pat. No. 2,919,195 describes an acidic fruit juice drink which is enriched with proteins and further ingredients. As the source of the proteins there are used skimmed milk powder, which contains 35 wt. % protein, the majority of which is casein, or whey powder with 10 wt. % protein (predominantly lactalbumin) or other milk proteins, which are in dried form. Creatine can also be added to the fruit juice drink. There is additionally described a method by means of which the fruit juice is produced. Casein has the disadvantage that it is one of the so-called slow acting proteins from which the amino acids are released only slowly during digestion. In addition, the protein sources used here have a comparatively low protein content and instead contain a significant proportion of further typical constituents of milk powders, for example, carbohydrates, in particular lactose.

In addition, Finnish patent FI 103089 B describes a foodstuff which comprises colostrum whey, creatine and carnitine and is in the form of freeze dried flakes. Freeze drying has the disadvantage that it is very expensive and in some cases very time consuming. In addition, the technical implementation of the method described in FI 103089B is very demanding because the technical apparatuses must satisfy high demands owing to the necessary vacuum of 0.1 mbar. Colostrum whey can be obtained from only a very small fraction of the milk, namely from the milk that is obtained within the first 10 hours after calving. This whey fraction contains very large amounts of immunoglobulins and growth factors, and so freeze drying, which is extremely gentle, is used for that reason. Against this background, colostrum whey must be considered a special product, the production of which must meet particular requirements. In addition, the described colostrum whey consists of only 20 wt. % protein, but approximately 50 wt. % carbohydrates are present. Colostrum whey is thus on the one hand a very expensive special product and on the other hand not suitable as a protein-rich and at the same time low-carbohydrate food supplement for athletes.

Starting from this prior art, the object underlying the present invention is to overcome the described disadvantages of the prior art. In addition, a product is to be provided which contains creatine or a salt thereof in predosed form, provides a stable form of creatine and/or a salt thereof and ensures good (further) processability. Furthermore, a product, in particular a food supplement, is to be provided which is safe to use in terms of the dosing of its ingredients, has a convenient form of administration, permits good handling and/or minimises intolerance to any secondary constituents. In addition, it is an object of the present invention to provide a method for producing this product and the form of administration.

The objects are achieved by a creatine protein matrix according to claim 1 and a method for producing a creatine protein matrix according to claim 12.

Thus, according to a first embodiment, the present invention relates to a creatine protein matrix which comprises
i) at least one protein component selected from the group of the whey protein concentrates, whey protein isolates, whey protein hydrolysates or mixtures thereof having a protein content in dry matter of at least 55 wt. %, and
ii) at least one creatine component selected from the group of creatine or a salt thereof, creatine monohydrate or mixtures thereof,
   the creatine protein matrix being in the form of a powder, in particular in the form of a powder having a mean particle size of from 10 to 250 μm, and at least 50% of the powder containing particles of which each individual particle comprises both the protein component and the creatine component, the creatine component being further preferably dispersed in the protein component.

Particularly preferably, the powder contains at least 60%, further preferably at least 70%, further preferably at least 80%, further preferably at least 90%, further preferably at least 95%, further preferably at least 98%, particles of which each individual particle comprises both the creatine component and the protein component, the creatine component being further preferably dispersed in the protein component.

Most particularly preferably, it is provided that the creatine protein matrix is in the form of a powder, in particular in the form of a powder having a mean particle size of from 10 to 250 μm, and each particle of the powder comprises the protein component and the creatine component, the creatine component being dispersed in the protein component.

According to a second embodiment of the present invention, the creatine protein matrix comprises, in addition to the creatine component and the protein component, preferably additionally iii) at least one mineral component which is preferably chosen from the group of the alkali and alkaline earth compounds. Particularly preferably, the mineral component from the group of the alkali or alkaline earth compounds can be added in the form of their salts, alkali or alkaline earth salts of phosphoric acid, diphosphoric acid, triphosphoric acid, citric acid, lactic acid, gluconic acid, double salts or mixtures being further preferred. Accordingly, the invention also relates to a creatine protein matrix which further comprises
iii) at least one mineral component selected from the group of the alkali or alkaline earth salts of phosphoric acid, diphosphoric acid, triphosphoric acid, citric acid, lactic acid, gluconic acid, double salts or mixtures thereof.

It is here further preferably provided that the creatine protein matrix is in the form of a powder, preferably in the form of a powder having a particle size of from 10 to 250 μm, and at least 50% of the powder contains particles of which each individual particle comprises at least one protein component selected from the group of the whey protein concentrates, whey protein isolates, whey protein hydrolysates or mixtures thereof having a protein content in dry matter of at least 55 wt. %, and at least one creatine component selected from the group of creatine or a salt thereof, creatine monohydrate or mixtures thereof, and at least one mineral component selected from the group of the alkali or alkaline earth salts of phosphoric acid, diphosphoric acid, triphosphoric acid, citric acid, lactic acid, gluconic acid, double salts or mixtures thereof.

Most particularly preferably, it is provided that the creatine protein matrix is in the form of a powder, preferably in the form of a powder having a mean particle size of from 10 to 250 μm, and each particle of the powder comprises the protein component, the creatine component and the mineral component.

Particularly preferably, the powder contains at least 50%, further preferably at least 60%, further preferably at least 70%, further preferably at least 80%, further preferably at least 90%, particularly preferably at least 95% and most particularly preferably at least 98% particles of which each individual particle comprises the creatine component, the protein component and the mineral component, the creatine component and the mineral component being further preferably dispersed in the protein component.

Most particularly preferably, it is provided that the creatine protein matrix is in the form of a powder having a mean particle size of from 10 to 250 μm and each particle of the powder comprises the protein component, the creatine component and the mineral component and the creatine component, in particular both the creatine component and the mineral component, are dispersed in the protein component.

The mean particle size according to the present invention is determined according to the examples as the x50 value.

According to the present invention, a creatine protein matrix is always to be understood as being an intimate mixture of the creatine component with the protein component and optionally the mineral component, the components of which mixture are so co-processed that said components cannot be separated from one another by simple separating methods such as sieving or sifting. The protein component forms the actual matrix in which the creatine component and optionally the mineral component are dispersed. According to the present invention, dispersion is achieved by dissolving or largely dissolving all the added ingredients in water in a one-pot method and thus co-processing them. It is thereby ensured that a one-phase system having at most a low solids content is obtained, in which, where a solids content is present, no sedimentation occurs through vigorous stirring. In order to remove the water content, suitable drying methods are to be employed, in particular spray drying, thin layer drying or roller drying. The homogeneous state of the solution or suspension is thereby retained in the dry product. The constituents are not separated from one another. A creatine protein matrix of the present invention thus differs from a mixture or blend of the individual components in that said components are present side by side and thus in such a manner that they can be separated from one another (for example by sieving or sifting). The creatine protein matrix is in the form of a powder, and each particle of the powder comprises the protein component and the creatine component, the creatine component being dispersed in the protein component. This procedure is also to be distinguished from a method in which two or more components from two or more different containers, which in addition may possibly be in different states of aggregation, are applied to one another, for example layer by layer, and/or purposively agglomerated during a drying process.

A sensorially pleasant, extremely homogeneous multicomponent product can thus be provided according to the present invention. The product is stable to storage and is excellently processable, mixing procedures as are used, for example, in the production of blends being unnecessary. Even small amounts of the creatine component or mineral component can be introduced extremely homogeneously in this manner. In particular for the creatine component, it was not to be expected that it would be processable in the present process so advantageously and without additional outlay in terms of work, because creatine is normally unstable under thermal load and additionally has limited solubility. After the process, the creatine component is finely and homogeneously distributed and thus dispersed in the protein. It has been shown, surprisingly, that the creatine component is no longer crystalline but has been converted to the amorphous state. The product thus represents an optimal form of administration for creatine.

According to a further advantageous embodiment, the present invention thus also relates to a creatine protein matrix which comprises
i) at least one protein component selected from the group of the whey protein concentrates, whey protein isolates, whey protein hydrolysates or mixtures thereof,
ii) at least one creatine component selected from the group of creatine or a salt thereof, creatine monohydrate or mixtures thereof, and optionally
iii) at least one mineral component selected from the group of the alkali or alkaline earth salts of phosphoric acid, diphosphoric acid, triphosphoric acid, citric acid, lactic acid, gluconic acid, double salts or mixtures thereof,
   the creatine protein matrix being in the form of a powder, in particular in the form of a powder having a mean particle size of from 10 to 250 μm, and the particles of the powder comprising the creatine component in amorphous form.

Particularly preferably, the creatine protein matrix is here in the form of a powder, in particular in the form of a powder having a mean particle size of from 10 to 250 μm, the powder containing at least 50%, further preferably at least 60%, further preferably at least 70%, further preferably at least 80%, further preferably at least 90%, particularly preferably at least 95% and most particularly preferably at least 98%, particles of which each individual particle comprises both the creatine component and the protein component, in particular the creatine component and the protein component and the mineral component, further preferably the creatine component, in particular both the creatine component and the mineral component, being dispersed in the protein component and the particles of the powder comprising the creatine component in amorphous form.

Particularly preferably, the creatine protein matrix is in the form of a powder, in particular in the form of a powder having a mean particle size of from 10 to 250 μm, each particle of the powder comprising the protein component and the creatine component, in particular the protein component, the creatine component and the mineral component, the particles comprising the creatine component in amorphous form.

Accordingly, a product can be provided in which the creatine component is present in a form which is administration- and application-friendly as well as safe to use. Further surprisingly, it has been shown that this creatine protein matrix has particularly good rehydration and dissolution behaviour.

According to a further embodiment, the present invention relates in particular to a creatine protein matrix which comprises or in particular contains

| | | |
|---|---|---|
| i) | from 50 to 95 wt.% | protein component, |
| ii) | from 5 to 40 wt.% | creatine component and optionally |
| iii) | from 0 to 10 wt.% | mineral component, |
| iv) | the matrix comprising or | water. |
| | in particular containing | |
| | not more than 10 wt. % | |

Accordingly, by consuming 10 g of this product, the consumer can very conveniently ingest up to 4 g of creatine component. Athletes like to take such products distributed in several portions throughout the day. If the product contains, for example, 10% creatine component, it is easily possible, by consuming three times 10 g, to consume 3 g of creatine, which corresponds to the current recommended intake of creatine in Europe. Likewise, in the case of a product containing 16% of a creatine component, it is possible by ingesting 3×10 g of the creatine protein matrix to ingest just under 5 g of creatine, which corresponds to the current recommendation in the USA. If the product additionally also contains 1.5% mineral component, for example, Ca₃(PO₄)₂, approximately 100 mg of calcium are additionally also ingested, which corresponds to 10% of the recommended daily intake. It has been shown to be particularly effective to consume creatine products and also protein products directly before or directly after sport. However, ingestion before going to bed has also been found to be advantageous. With a dose of the creatine protein matrix (10 g), up to 170 kJ can be ingested; on the other hand, the calorific value can, however, be reduced to just under 80 kJ/portion. A portion size of 10 g has here been assumed. It is clear that this is not a food replacement or a foodstuff in itself but is to be seen as a food supplement in situations of increased energy requirement, for example in sport.

By maintaining these concentration ranges it is possible to provide a product which comprises a creatine component in a particularly advantageous mixing ratio with the protein component and optionally the mineral component. In particular, it can also be provided that the creatine protein matrix contains those components. However, it should be pointed out in this connection that the protein component of the present invention is a natural product and can itself comprise further substances in addition to the protein. In this connection, mention should be made in particular of any fats, minerals and carbohydrates which may be present. Accordingly, the chosen protein component may contain a maximum of 25% carbohydrates and a maximum of 8% fat, in particular a maximum of 15% carbohydrates and a maximum of 6% fat. Particular preference is given to protein raw materials which contain less than 5% carbohydrates and less than 4% fat. The mineral content (determined as ash) should be not more than 8%, in particular not more than 6%. Particular preference is given to protein raw materials having a mineral content of a maximum of 5%. Accordingly, a particularly preferred creatine protein matrix according to the invention always contains, in addition to the listed components, further ingredients in naturally fluctuating proportions, which further ingredients are introduced by the protein component. According to the present invention, a creatine protein matrix which contains components i) to iv) is thus to be understood as being a matrix in the production of which, apart from the mentioned components, there is not used any further substance, such as carbohydrates, vitamins or other ingredients, which would have to be introduced in addition.

All percentages herein are based on weight, unless indicated otherwise.

At the same time or independently, a creatine protein matrix according to the invention comprises or contains not more than 10 wt. % water, in particular not more than 7 wt. % water, further preferably not more than 5 wt. % water, most particularly preferably not more than 3 wt. % water. It is thus possible to provide a creatine protein matrix which is particularly stable to storage and which in particular is stable from the microbiological point of view and also stable in respect of degradation reactions of creatine.

Further preferably, it can be provided that the creatine protein matrix comprises or contains in particular at least 50 wt. % protein component, preferably at least 60 wt. %, particularly preferably at least 70 wt. % and most particularly preferably at least 80 wt. % protein component. It can thereby also be provided that the proportion of protein component is not more than 95 wt. %. Within the scope of the present invention, the amounts of protein component present are always based, in the case of the concentrates, hydrolysates or isolates, on the protein and any further natural ingredients, for example carbohydrates, fat, trace elements and vitamins, which are present in the natural products. At the same time or independently, the creatine protein matrix according to the invention can comprise or contain in particular at least 5.0 wt. % creatine component, preferably at least 8.0 wt. %, particularly preferably at least 10.0 wt. %. It can thereby also be provided that the proportion of creatine component is not more than 40 wt. %, in particular not more than 30 wt. %.

According to a further development of the invention, it can also be provided that a creatine protein matrix according to the invention comprises or contains not more than 10 wt. % fats, in particular not more than 8 wt. % fats, and/or not more than 10 wt. % water. With regard to the further components fats and water, it has been shown within the scope of tests that it is thus possible to provide a creatine protein matrix which is particularly easy to measure out. Particularly surprisingly, it has been found that the pourability and flow behaviour of such a creatine protein matrix are particularly good.

Within the scope of the present invention there can be used as the creatine component creatine, creatine monohydrate or creatine salts and mixtures thereof. Creatine components which are preferably to be used are in particular creatine, creatine monohydrate and creatine salts selected from the group of creatine ascorbate, creatine dihydroascorbate, creatine citrate, creatine-citric acid compounds in the molar ratio 1:1 to 3:1, creatine alpha-ketoglutarate, creatine pyruvate, creatine phosphate, creatine acetate, creatine maleate, creatine malate, creatine fumarate, creatine gluconate, creatine formate, creatine aspartate, creatine phosphoenolpyruvate, creatine folate, creatine dihydrolipoate or creatine lipoate or arbitrary mixtures thereof. Of course, any other suitable and physiologically acceptable creatine derivatives which follow the concept of the invention can be used, for example dicreatine, creatine esters, phosphocreatine, creatine ethyl ester. Creatine monohydrate is particularly preferred.

According to the invention there is used as the protein component at least one protein component selected from the group of the whey protein concentrates, whey protein isolates, whey protein hydrolysates or mixtures thereof. The protein components are distinguished in that they can be obtained by established methods from the whey of in particular cow's milk, goat's milk or sheep's milk and provide a very nutritious and easily digestible protein. The protein content of this fraction is in particular rich in branched amino acids and is therefore relevant for muscle formation.

For the production of whey protein concentrates, isolates and hydrolysates, the whey obtained after acid or rennet precipitation is treated by means of membrane filtration methods, electrodialysis, ion exchange chromatography, partial hydrolysis or crystallisation operations such that the desired fractions or products are obtained.

Sweet and acid whey powders from cow's milk according to the present invention have the following typical compositions (based on dry matter):

| | Lactose | Protein | Fat | Ash | Water |
|---|---|---|---|---|---|
| | [wt. %] | [wt. %] | [wt. %] | [wt. %] | [wt. %] |
| Sweet whey | ≧70 | ≧12 | ≦1.5 | ≦8.5 | ≦3.5 |
| Acid whey | ≧65 | 9 ± 1 | — | 11 ± 1 | ≦3.5 |

The protein content in the whey can be increased by suitable methods. It is thus possible, for example, to obtain whey protein concentrates having different protein contents. The concentrate usually used for food for athletes has a protein content of from at least 55 wt. % to approximately 80 wt. % (based on the dry matter of the whey protein concentrate—WPC-60 or WPC-80). The protein fraction is enriched by ultrafiltration, optionally combined with diafiltration. Such a retentate produced by ultrafiltration has, for example, the following composition in the dry substance, it being possible of course for the contents to vary within certain ranges:

| | Protein | Lactose | Fat | Ash | Water |
|---|---|---|---|---|---|
| | [wt. %] | [wt. %] | [wt. %] | [wt. %] | [wt. %] |
| WPC-60 | 59-63 | 0.0-22.0 | 2.5-5.0 | 3.0-5.0 | 3.0-6.0 |
| WPC-80 | 78-82 | 0.0-4.5 | 3.5-7.0 | 3.0-5.0 | 3.0-5.0 |

The retentate, in contrast to the permeate, is the portion that is retained by the membrane during membrane filtration. By drying the retentate, the whey protein concentrate is finally obtained by this method.

In order to obtain whey protein isolates (WPI), a further working step must be inserted in the processing of the whey. Prior to ultrafiltration, the whey is first subjected to microfiltration, for example, to remove the fat. Another option is an additional chromatography step. Protein powders which contain >90% protein (in dry matter) are finally obtained.

A typical composition according to the present invention is to be found in the following table.

| | Protein | Lactose | Fat | Ash | Water |
|---|---|---|---|---|---|
| | [wt. %] | [wt. %] | [wt. %] | [wt. %] | [wt. %] |
| WPI | 90-96 | 0.0-3.0 | 0.4-1.0 | 1.5-2.5 | 3.0-5.0 |

If the retentates obtained after membrane filtration are subjected to hydrolysis/proteolysis, suitable whey protein hydrolysates (WPH) can be obtained.

Whey protein hydrolysates are produced by enzymatic hydrolysis of the whey protein isolates or concentrates. By means of the hydrolysis or proteolysis, the natural protein is cleaved into smaller fragments. As a result, the natural protein on the one hand changes in terms of taste; on the other hand, the digestibility improves. In addition, the allergenic potential falls.

According to the present invention, the composition can be as follows:

| | Protein | Lactose | Fat | Ash | Water |
|---|---|---|---|---|---|
| | [wt. %] | [wt. %] | [wt. %] | [wt. %] | [wt. %] |
| WPH | 76-82 | 0.0-4.0 | 3.0-5.5 | 3.5-5.0 | 3.0-5.0 |

Accordingly, a creatine protein matrix according to the present invention comprises a protein component selected from the group of whey protein concentrate, whey protein hydrolysate or whey protein isolate, which in turn has a protein content of at least 55 wt. % protein in dry matter. Particularly preferably, a creatine protein matrix comprises or contains as the protein component a whey protein concentrate having a protein content in dry matter of at least 75 wt. %. In a further embodiment, the creatine protein matrix is produced using a whey protein hydrolysate having a protein content in dry matter of at least 75 wt. %. It is also particularly suitable in this context to use a whey protein isolate having a protein content in dry matter of at least 90 wt. %.

Whey protein concentrates, isolates and hydrolysates also contain a significant proportion of lactose, depending on the quality. Lactose in the product can be depleted by suitable methods. One option is to concentrate the whey and remove lactose by crystallisation. The degradation of lactose by enzymatic hydrolysis is also possible, the lactose being cleaved into glucose and galactose. This can be carried out by the enzyme lactase, which is obtainable in acidic or neutral enzyme preparations. A concentration of lactose in the dry product of less than 0.1% is usually referred to as “lactose-free”.

According to a preferred embodiment, the protein component used, in particular the whey protein concentrate or isolate or hydrolysate, or the creatine protein matrix can be lactose-free. By using lactose-free whey protein concentrates it is possible to provide a product and food supplement which is particularly well tolerated by the user. In particular, it is thus possible to produce and provide a creatine protein matrix which can be ingested by users with lactose intolerance.

In connection with the present invention, lactose-free is understood as meaning a protein component or a creatine protein matrix which is substantially free of lactose and in particular contains, as a result of its production, not more than 0.1 wt. % lactose or most particularly preferably no lactose.

There can be used as the mineral component in particular the alkali and alkaline earth salts of phosphoric acid (orthophosphoric acid), diphosphoric acid or triphosphoric acid, citric acid, lactic acid, gluconic acid, double salts or mixtures thereof. The alkali and alkaline earth salts of these acids are in some cases sparingly soluble salts which naturally also occur in the milk. They are not only physiologically valuable constituents of the milk but can also contribute towards stabilising the protein constituents of the milk by forming chelates and/or complexes. This is the case in particular for the divalent cations Ca²⁺ and Mg²⁺. When the milk is fractionated, some of the minerals are also removed, and therefore it is expedient to add further such substances to the protein-creatine matrix. There are thus added nutritionally valuable minerals which, as a result of the production process, are found in the target product in a predosed and defined amount.

There can particularly advantageously be used as the mineral component alkali or alkaline earth salts of phosphoric acid, in particular selected from the group of sodium dihydrogen phosphate, disodium hydrogen phosphate, trisodium phosphate, calcium hydrogen phosphate, tricalcium phosphate, dicalcium dihydrogen phosphate, calcium tetrahydrogen phosphate, magnesium hydrogen phosphate, magnesium dihydrogen phosphate, magnesium phosphate, salts of citric acid sodium dihydrogen citrate, disodium hydrogen citrate, trisodium citrate, calcium citrate, magnesium citrate, tricalcium dicitrate, salts of lactic acid sodium lactate, calcium lactate, magnesium lactate, salts of gluconic acid sodium gluconate, calcium gluconate, magnesium gluconate or mixtures thereof.

Surprisingly, it has been shown that the sparingly soluble calcium and magnesium phosphates can also be incorporated into the protein-creatine matrix without problems (no sedimentation). The bitter taste of the calcium and magnesium salts which otherwise often occurs is not perceived in this matrix since the protein component masks the bitter taste. The phosphates of the divalent cations calcium and magnesium in particular lead to an optical brightening of the product, which makes it appear even more attractive.

During physical exertion, a balanced electrolyte balance is of critical importance. In particular for the divalent ions Ca²⁺ and Mg², absorption during the process of digestion is improved in the creatine protein matrix. In addition, synergistic effects are to be expected here, since calcium and creatine in particular have a positive effect on bone health. The salts of phosphoric acid in the creatine protein matrix also enhance the buffering effect of the two individual components protein and creatine, and therefore the pH profile in the stomach, and thus the utilisation and absorption of the components, is improved.

In a further embodiment, the alkali and/or alkaline earth ions can also be introduced into the product by using the alkali and/or alkaline earth hydroxides. This can advantageously be carried out by also using the alkali and/or alkaline earth hydroxides to adjust the pH during the production of the product. Since the amount of the corresponding ions to be introduced via the alkali and alkaline earth hydroxides is only limited—the limiting factor here is the pH—it may be found to be necessary to use in addition the alkali or alkaline earth salts of phosphoric acid selected from the group of sodium dihydrogen phosphate, disodium hydrogen phosphate, trisodium phosphate, calcium hydrogen phosphate, tricalcium phosphate, dicalcium dihydrogen phosphate, calcium tetrahydrogen phosphate, salts of citric acid sodium dihydrogen citrate, disodium hydrogen citrate, trisodium citrate, calcium citrate, tricalcium dicitrate, salts of lactic acid sodium lactate, calcium lactate, salts of gluconic acid sodium gluconate, calcium gluconate or mixtures thereof.

A creatine protein matrix according to the present invention is always to be understood as being an intimate mixture of the creatine component with the protein component and optionally the mineral component, in which said components are in solid form and are co-processed such that the components on the one hand cannot easily be separated from one another and on the other hand are distributed homogeneously in one another. The protein component thereby forms the actual matrix in which the creatine component and optionally the mineral component is homogeneously distributed or dispersed.

A creatine protein matrix according to the invention has in particular a very uniform particle size distribution with a mean particle size of between 10 and 250 μm, in particular between 10 and 150 μm, in particular between 10 and 100 μm and most particularly preferably between 10 and 80 μm. These matrices exhibit flow properties which are typical of proteins. On account of their properties, they can be processed further without problems, for example using corresponding auxiliary substances also to compacts (tablets) or as an additive for producing bars. Instantisation of the powder is also possible, powders having a mean particle size of between 100 and 250 μm being obtained.

Further surprisingly, the creatine protein matrix, in particular having a mean particle size of between 10 and 250 μm, in particular between 10 and 200 μm, in particular between 10 and 150 μm, in particular between 10 and 100 μm and most particularly preferably between 10 and 80 μm, exhibits a dissolution or dispersing behaviour which is typical of proteins. The creatine component, however, has significantly improved dissolution or dispersing behaviour because, when measured out conventionally in the form of a drink (10 g of creatine protein matrix in 100 ml of water), a drink with a pleasant mouthfeel is obtained and no crystalline sediment is to be noticed. The creatine component and optionally the mineral component are thus present in a highly bioavailable form.

The stirring-in behaviour of the creatine protein matrix is likewise typical of proteins and can be further optimised by suitable instantisation methods. To that end, the powder can be subjected to surface treatment with lecithin, for example. A further option is agglomeration in a fluidised bed apparatus, a porous agglomerate being obtained which, in comparison with the powder as such, exhibits very good wettability with water.

Preference is further given to a creatine protein matrix which is in the form of a powder and has a bulk density of from 250 to 500 g/l, in particular a bulk density of from 340 to 450 g/l.

Further preferably, the proportion of acids and/or bases in the creatine protein matrix is adjusted such that the creatine protein matrix, when added to water, establishes a pH of from 7.0 to 8.0, in particular a pH of from 7.1 to 7.8. It can be advantageous to choose for the production of the matrix a protein component which itself establishes a pH of from 7.0 to 8.0, in particular a pH of from 7.1 to 7.8, when water is added. At the same time or alternatively, the production process for producing the matrix may also be conducted in such a manner that a pH of from 7.0 to 8.0, in particular from 7.1 to 7.8, is maintained.

If the chosen pH is too alkaline (>pH 8.0), ammonia compounds form, which adversely affect the taste and odour of the product. Likewise, the chosen pH must not be too low (<pH 7.0) in order additionally to prevent the conversion of creatine to creatinine, which is marked in particular at acid pH values (pH <6).

Accordingly, the invention also relates to a creatine protein matrix which in water establishes a pH of from 7.0 to 8.0, in particular a pH of pH 7.1 to 7.8, or which comprises a protein component which itself establishes a pH of pH 7.0 to 8.0, in particular a pH of pH 7.1 to 7.8, in water.

Further preferred according to the present invention is a creatine protein matrix which has a calorific value of from 700 to 1700 kJ/100 g. The calorific value varies depending on the protein component used and also the further constituents. The creatine component and the mineral component do not contribute to the calorific value, and therefore it is determined solely by the protein component used and the proportion of the protein component in the matrix. However, particular preference is given to a creatine protein matrix which, apart from the mentioned constituents, does not contain any further additions of, for example, carbohydrates, fats or further proteins. Such added substances would increase the calorific value of the matrix to an extent which is not desirable.

Accordingly, when, for example, a WPI having a protein content of 90% i.d.m. (1.2% CH, 1% fat) and a protein content in the matrix of 85% is used, a product having a calorie content of 1347 kJ/100 g can be obtained. If a whey protein concentrate (78% protein i.d.m., 3.5% CH, 1.5% fat) is used instead of a whey protein isolate, the calorie content falls to 1224 kJ/100 g.

If the protein content in the matrix is reduced to 50% using a WPC-60 (61% protein i.d.m., 21% CH, 5% fat), a very low calorie content of 790 kJ/100 g is obtained. On the other hand, the calorie content can be increased to 1700 kJ/100 g by suitably choosing the ingredients and proportions. The creatine protein matrix can thus also be adapted to the particular needs in terms of the calorie content.

According to a further concept, the present invention also includes a food supplement for athletes which comprises or contains a creatine protein matrix described herein.

In addition, according to a further concept, the present invention also relates to a method for producing a creatine protein matrix in powder form. Accordingly, the present invention also relates to a method for producing a creatine protein matrix in powder form, which method comprises the method steps:
a) providing an aqueous, pasteurised solution or suspension Lq1 comprising at least one protein component selected from the group of the whey proteins, whey protein concentrates, whey protein isolates, whey protein hydrolysates or mixtures thereof; and
b) preparing a solution or suspension Lq2 by adding at least one creatine component selected from the group of creatine or a salt thereof, creatine monohydrate or mixtures thereof, and optionally a salt component selected from the group of the alkali or alkaline earth salts of phosphoric acid, diphosphoric acid, triphosphoric acid or mixtures thereof, simultaneously or in succession to the solution or suspension Lq1 provided; and
c) drying the prepared solution or suspension Lq2 by means of spray drying, thin layer evaporation or roller drying methods.

It has thereby been shown, particularly surprisingly and unforeseeably, that a product having a particularly homogeneous distribution of the components can be provided by method step c). The creatine protein matrix thus produced has in particular a particularly homogeneous distribution of the creatine component and of the mineral component in the protein component. In addition, it is thus possible to provide a product in which creatine is finely divided in amorphous form and thus is in a form which dissolves very quickly.

In a preferred method it is in particular also provided that the creatine component is added to the pasteurised solution or suspension Lq1 only shortly before drying. The period should not exceed 3 hours, in particular it should not exceed 1 hour. Particularly preferably, the creatine component should be added to the solution or suspension Lq1 only 30 minutes before drying. Surprisingly, addition after pasteurisation does not adversely affect the microbiological properties of the product. In addition, despite the normally very low solubility of creatine MH, a homogeneous suspension is formed which leads to an extremely homogeneous end product.

Further preferably, there is used in the method a solution or suspension Lq1 which is lactose-free and/or contains a whey protein concentrate, isolate or hydrolysate having a protein content of at least 60 wt. % (in dry matter). This is to be understood as meaning that, if the solution Lq1 were to be dried without adding further ingredients, the particular product mentioned, specifically a whey protein concentrate, isolate or hydrolysate, would be obtained.

Further advantageously, the creatine component is added to the pasteurised solution or suspension Lq1 at temperatures of between 20° C. and 30° C. and further preferably at a pH of between pH 7.0 and pH 8.0, in particular between pH 7.1 and pH 7.8. The pH is thereby advantageously adjusted using alkali and/or alkaline earth hydroxides, such as sodium hydroxide, potassium hydroxide, magnesium hydroxide and/or calcium hydroxide. The addition of the creatine component is in each case not carried out until after the pasteurisation of the protein component.

Most particularly preferably, the temperature during hot drying is adjusted such that the product temperature is of between 50° C. and 120° C., in particular between 60 and 100° C., particularly preferably between 60 and 90° C. Despite the thermal load during drying, it is thereby possible to obtain a product which unexpectedly has a very low creatinine content. This is all the more surprising as it is known that, under thermal load, creatine is very quickly converted into creatinine, which cannot be utilised by the body. The creatine protein matrix according to the invention comprises in particular less than 1 wt. %, yet more preferably less than 0.1 wt. %, creatinine. In addition, there is obtained a free-flowing product which is stable to storage and in which no further addition of flow aids or separating agents is necessary. No discolouration occurs through the presence of the creatine component and the mineral component. In fact, a surprisingly light product is obtained.

Without being bound to theory, it appears to be possible by means of the process to obtain a matrix in which the creatine component is very finely dispersed in the protein component. It is thereby even observed that the creatine component is no longer in crystalline form but has changed to the amorphous state. In the chosen drying methods, the homogeneous state of the solution is conserved by evaporating the water off suddenly.

In the case of spray drying, the solution or suspension to be dried is finely atomised in a drying tower by means of atomising nozzles or rotary nozzles. The solution or suspension is thereby atomised with a pressure of from 2 to 20 bar. As a result of gravity, the droplets fall downwards into the drying air that is supplied, said droplets drying within seconds. The drying air is supplied at a temperature of from 120 to 200° C., while a temperature of between 70 and 90° C. prevails in the dryer. The product is obtained at the bottom end of the dryer as a dry product in powder or flake form.

According to a particularly preferred embodiment of the method, it is also provided that the solution or suspension Lq1 contains at least 30 wt. % dry matter.

In the case of the roller or thin layer dryer, the suspension is dried in the form of a thin film. This takes place either on a heated roller or on the inside of a heated pipe. The temperature of the roller or pipe is between 105 and 155° C. By applying a vacuum, the temperature of the roller or pipe can be reduced to below 100° C. The dry material is then scraped off the roller or inside wall. The flakes obtained are comminuted by means of a mill and can thus be adjusted to the desired particle size.

All these drying methods can be controlled such that a product having a very uniform particle size distribution having a mean particle size of between 10 and 250 μm, in particular between 10 and 200 μm, in particular between 10 and 100 μm and most particularly preferably between 10 and 80 μm, is obtained.

The present invention will be explained in the following by means of examples, but the invention is not to be understood as being limited to the examples. In fact, any combination of preferred embodiments is likewise included in the present invention. In the figures

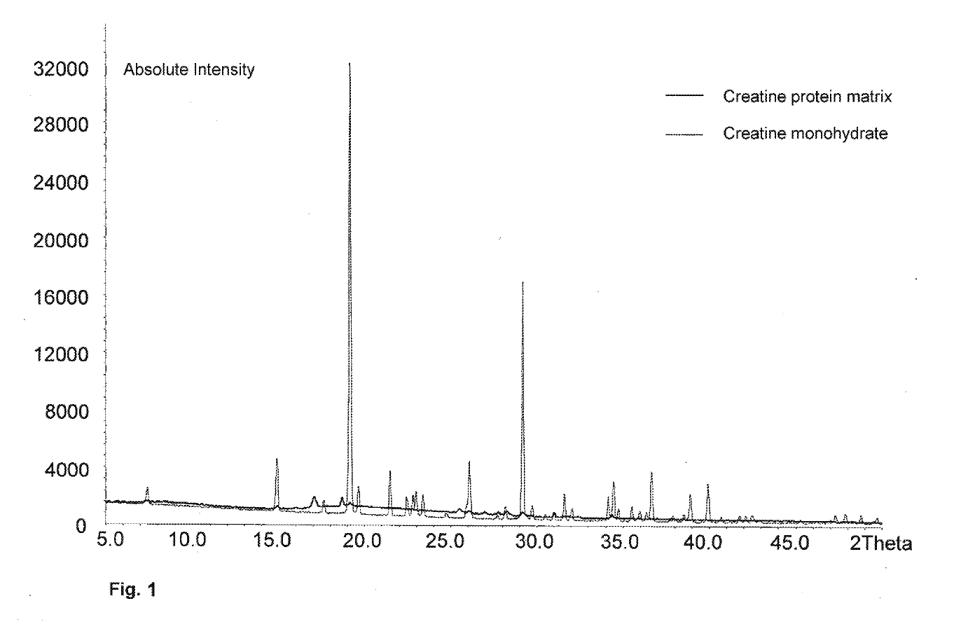

FIG. 1 shows a comparison of the powder diffractograms of a matrix according to the invention and crystalline creatine monohydrate.

### EXAMPLES

The whey protein retentates or solutions used in the following examples formally yield, depending on the preceding treatment, either whey protein concentrates (WPC), whey protein isolates (WPI) or whey protein hydrolysates (WPH). This is to be understood as meaning that, if the solution Lq1 were to be dried without adding further ingredients, the particular product mentioned, specifically a whey protein concentrate, isolate or hydrolysate, would be formed.

### Test Methods

### 1) Segregation

The homogeneity of the creatine protein matrix can be tested by means of a segregation test. In this test, the creatine protein matrix and a simple mixture (blend) of the three constituents are compared with one another. Both formulations are again mixed thoroughly before the test. For the test, the test mixture is placed in a funnel. The product is allowed to flow from the funnel onto a conveyor belt, which transports the product to a cylindrical receiving container. A cone of test material builds up in said receiving container, the fine material accumulating in the inner portion of the cone while the coarse material rolls along the outside edges. The inner portion of the cone can be removed from the receiving vessel through a central opening, while the outer portion of the cone remains in the vessel. The composition of the fractions thus obtained can then be tested. The homogeneity is determined by means of the covariance CV=SD×100/mean, the mean being determined over all the analysis results (cone core and outside edges). If CV is <30%, the mixture can be assumed to be homogeneous with a low tendency to demixing; if CV is between 30 and 40%, a moderate tendency to demixing can be assumed, and at CV>40% a high tendency to demixing can be assumed.

### 2) Particle Size Distribution

The particle size distribution of the product is determined by means of laser diffraction. This procedure is suitable in particular for powders having a particle size <1000 μm. Requirements and information regarding the design of the apparatus, system verification, sampling, sample measurement and the models for calculating the particle size distribution from the light scattering pattern can be found in ISO 13320:2009.

For the measurement, 10 g of sample are introduced via a transport chute into the sample chamber, through which a laser shines. The incoming particles cause refraction or deflection of the laser beam, depending on the particle size. The data can be converted into a particle size distribution by means of Fourier transformation. The mean particle size (x50 value) in μm can be read off from the particle size distribution.

### 3) Bulk Density

For the bulk density, 200 g of sample are introduced in a free-flowing manner into a measuring cylinder via a funnel. The measuring cylinder containing the sample is allowed to stand for 10 minutes, and the volume is then read off. The bulk density is given in g/l.

### 4) Ingredients

Creatine and creatinine are determined by HPLC.

For determining the protein content, the nitrogen content is first determined by means of the Dumas or the Kjeldahl method. Via a conversion factor (N×6.38 or N×6.25), the protein content can be calculated, which must be corrected by the proportion of creatine present. Na, K, Ca and Mg are determined by means of atomic absorption spectroscopy.

### Example 1

### a) Production of the Creatine Protein Matrix in Powder Form

1400 kg of ultrafiltered whey protein retentate (lactose-free (max. 0.1% i.d.m.), 40% dry matter, protein content 81% i.d.m., pH: 7.0 to 7.4) are placed, after being pasteurised, in a storage container which is adjusted to a temperature of 30° C. The retentate is stirred constantly. 108 kg of creatine MH (creatine monohydrate) are metered into the container, followed by 14 kg of tricalcium orthophosphate (solid metering). The mixture is stirred vigorously for 30 minutes until a homogeneous, cloudy solution is present. The pH is then checked and optionally adjusted to 7.2 to 7.4 with aqueous NaOH. The cloudy solution thus obtained is passed onto the spray tower via a heat maintenance section (80° C., 65 seconds) and spray dried. The air inlet temperature is 160° C., while a temperature of 78° C. prevails in the spray tower. Approximately 650 kg of a white to light-beige powder are obtained.

### b) Characterisation of the Creatine Protein Matrix in Powder Form

The powder has the following composition: 81 wt. % whey protein concentrate, 14 wt. % creatine, 2 wt. % tricalcium orthophosphate, 3 wt. % water.

Lactose content: <0.1%

Creatinine content: <0.05%

Mean particle size: x50 value: 35 μm

Bulk density: 400 g/l

Calorie content: 1300 kJ/100 g

Segregation test: CV<5%

The resulting creatine protein matrix according to Example 1 is an intimate mixture of the creatine component and the protein component, in which the components cannot be separated from one another. The creatine is present in homogeneously distributed and amorphous form in the protein matrix. The matrix produces a pH of 7.2 in water.

The amorphous state of creatine is shown in FIG. 1.

The figure shows a comparison between crystalline creatine monohydrate and a creatine protein matrix. The absolute intensities of the signals are plotted over the diffraction angle. It is clear from the comparison of the curves that only weak signals are recorded in the case of the co-processed mixture, which additionally cannot be correlated with creatine monohydrate. The absence of sharp diffraction reflections is an indication that the product contains scarcely any or no crystalline constituents; it is thus in amorphous form.

For the consumer, the creatine protein matrix represents a form of this food supplement which is easy to measure out. The product can, for example, easily be dispensed, provided with further ingredients (carbohydrates, fats, vitamins, sweeteners, etc.) or used as an ingredient for the preparation of foodstuffs, such as bars, for example. For direct consumption, the powder is advantageously flavoured and, under some circumstances, a colourant is added.

### Example 2

### a) Production

1400 kg of partially hydrolysed whey protein retentate (40% dry matter, pH: 7.2 to 7.4, protein content 79% i.d.m.) are placed, after being pasteurised, in a storage container which is adjusted to a temperature of 30° C. 49 kg of creatine MH are metered into said container, followed by 10 kg of trimagnesium orthophosphate (solid metering). The mixture is stirred vigorously for 20 minutes until a slightly cloudy solution is present. The pH is then checked and optionally adjusted to 7.1 to 7.4 with NaOH. The suspension/paste thus obtained is dried on a roller dryer at 3.5 bar and a roller temperature of 120° C. Further conditions: roller speed 10 rpm. The resulting flakes are made into a powder by means of a powder mill. Approximately 610 kg of a white to light-beige powder are obtained.

### b) Characterisation

The powder has the following composition: 90.4 wt. % whey protein hydrolysate, 7 wt. % creatine, 1.6 wt. % trimagnesium orthophosphate, 1 wt. % water.

Creatinine content: <0.05%

Bulk density: 250 g/l

Mean particle size: x50 value: 200 μm

Calorie content: 1455 kJ/100 g

Segregation test: CV<5%

The resulting creatine protein matrix according to Example 2 is an intimate mixture of the creatine component and the protein component, in which the components cannot be separated from one another. The creatine is present in homogeneously distributed and amorphous form in the protein matrix. The matrix produces a pH of 7.3 in water.

### Example 3

### a) Production

1400 kg of ultrafiltered whey protein retentate (50% dry matter, pH: 7.1 to 7.2, protein content 62% i.d.m.) are placed, after being pasteurised, in a storage container which is adjusted to a temperature of 35° C. 264 kg of creatine MH are metered into the container, followed by 46.6 kg of tricalcium dicitrate (solid metering). The mixture is stirred vigorously for 40 minutes until a homogeneous suspension/paste is present. The pH is then checked and optionally adjusted to 7.1 to 7.2 with KOH. The cloudy solution thus obtained is dried as in Example 1.

### b) Characterisation

The powder has the following composition: 69 wt. % whey protein concentrate, 23 wt. % creatine, 5 wt. % tricalcium dicitrate, 3 wt. % water.

Creatinine content: <0.05%

Mean particle size: x50 value: 55 μm

Bulk density: 280 g/l

Calorie content: 940 kJ/100 g

Segregation test: CV <5%

The resulting creatine protein matrix according to Example 3 is an intimate mixture of the creatine component and the protein component, in which the components cannot be separated from one another. The creatine is present in homogeneously distributed and amorphous form in the protein matrix. The matrix produces a pH of 7.2 in water.

### Example 4

### a) Production

2500 kg of whey protein solution (40% dry matter, pH: 7.1 to 7.4, protein content 93% i.d.m.) are placed, after being pasteurised, in a storage container which is adjusted to a temperature of 50° C. In a second container, 800 kg of creatine MH are suspended in 1000 l of water at 20° C. The retentate and the creatine suspension are mixed with one another continuously and highly vigorously in a third container and then immediately passed onto the spray tower via a heat maintenance section (temperature: 85° C., 45 seconds) and spray dried. The air inlet temperature is 170° C., the spray tower temperature is 85° C. Approximately 1660 kg of a white to light-beige powder are obtained.

### b) Characterisation

The powder has the following composition: 56.9 wt. % whey protein isolate, 40.0 wt. % creatine, 3 wt. % water.

Creatinine content: <0.05%

Mean particle size: x50 value: 40 μm

Bulk density: 420 g/l

Calorie content: 940 kJ/100 g

Segregation test: CV<5%

The resulting creatine protein matrix according to Example 4 is an intimate mixture of the creatine component and the protein component, in which the components cannot be separated from one another. The creatine is present in homogeneously distributed and amorphous form in the protein matrix. The matrix produces a pH of 7.1 in water.

### Example 5

### a) Production

236 kg of creatine MH and 10 kg of calcium lactate are added to 2000 kg of ultrafiltered whey protein retentate (40% dry matter, pH: 7.1 to 7.3, protein content 79% i.d.m.) and the mixture is mixed thoroughly and pasteurised for 5 minutes at 62° C. The mixture is then cooled to 30° C. The cloudy solution thus obtained is passed onto the spray tower via a heat maintenance section (90° C., 30 seconds) and spray dried. Approximately 1005 kg of a white to light-beige powder are obtained.

### b) Characterisation

The powder has the following composition: 75.5 wt. % whey protein concentrate, 18.6 wt. % creatine, 1.0 wt. % calcium lactate, 4 wt. % water.

Creatinine content: 0.9%

Calorie content: 1190 kJ/100 g

Segregation test: CV <5%

### Example 6

### a) Production of the Creatine Protein Matrix in Powder Form

1990 kg of ultrafiltered whey protein retentate (lactose-free (max. 0.1% i.d.m.), 40% dry matter, protein content 80% i.d.m., pH: 7.0 to 7.4) are placed, after being pasteurised, in a storage container which is adjusted to a temperature of 30° C. The retentate is stirred constantly. 205 kg of creatine MH (creatine monohydrate) are metered into the container (solid metering). The mixture is stirred vigorously for 30 minutes until a homogeneous, cloudy solution is present. The pH is then checked and optionally adjusted to 7.2 to 7.4 with aqueous NaOH. The cloudy solution thus obtained is passed onto the spray tower via a heat maintenance section (80° C., 70 seconds) and spray dried. The air inlet temperature is 160° C., while a temperature of 75° C. prevails in the spray tower. Approximately 990 kg of a white to light-beige powder are obtained.

### b) Characterisation of the Creatine Protein Matrix in Powder Form

The powder has the following composition: 79 wt. % whey protein concentrate, 18 wt. % creatine, 3 wt. % water.

Lactose content: <0.1%

Creatinine content: <0.05%

Mean particle size: x50 value: 45 μm

Bulk density: 420 g/l

Calorie content: 1220 kJ/100 g

Segregation test: CV<5%

### Example 7

As Example 1, but calcium citrate is used instead of tricalcium orthophosphate.

1.-16. (canceled)

17. A creatine protein matrix comprising:
i) at least one protein component selected from the group consisting of whey protein concentrates, whey protein isolates, whey protein hydrolysates and mixtures thereof, having a protein content in dry matter of at least 55 wt. %; and,
ii) at least one creatine component selected from the group consisting of creatine, a salt thereof, creatine monohydrate and mixtures thereof,
wherein the creatine protein matrix is in the form of a powder having a mean particle size of from 10 to 250 μm, and at least 50% of the powder contains particles wherein each individual particle comprises both the creatine component and the protein component.

18. The creatine protein matrix of claim 17, wherein the creatine protein matrix further comprises
iii) at least one mineral component selected from the group consisting of alkali or alkaline earth salts of phosphoric acid, diphosphoric acid, triphosphoric acid, citric acid, lactic acid, gluconic acid, double salts and mixtures thereof,
wherein the creatine component and the mineral component are dispersed in the protein component.

19. The creatine protein matrix of claim 17, wherein the creatine protein matrix comprises:
i) from 50 to 95 wt. % of the protein component;
ii) from 5 to 40 wt. % of the creatine component; and,
iii) not more than 10 wt. % water.

20. The creatine protein matrix of claim 18, wherein the creatine protein matrix comprises:
i) from 50 to 95 wt. % of the protein component;
ii) from 5 to 40 wt. % of the creatine component;
iii) from 0 to 10 wt. % of the mineral component; and,
iv) not more than 10 wt. % water.

21. The creatine protein matrix of claim 17, wherein the creatine protein matrix or the protein component is lactose-free.

22. The creatine protein matrix of claim 17, wherein the protein component is a whey protein concentrate, a whey protein isolate or a whey protein hydrolysate having a protein content of at least 75 wt. % protein.

23. The creatine protein matrix of claim 17, wherein the creatine protein matrix or the protein component comprises not more than 10 wt. % fats and/or not more than 10 wt. % water.

24. The creatine protein matrix of claim 18, wherein the alkali or alkaline earth salt of phosphoric acid, diphosphoric acid, triphosphoric acid, citric acid, lactic acid or gluconic acid is selected from the group consisting of sodium dihydrogen phosphate, disodium hydrogen phosphate, trisodium phosphate, calcium hydrogen phosphate, tricalcium phosphate, dicalcium dihydrogen phosphate, calcium tetrahydrogen phosphate, sodium dihydrogen citrate, disodium hydrogen citrate, trisodium citrate, calcium citrate, tricalcium dicitrate, sodium lactate, calcium lactate, sodium gluconate and calcium gluconate.

25. The creatine protein matrix of claim 17, wherein the creatine protein matrix is in the form of a powder having a mean particle size of from 10 to 100 μm.

26. The creatine protein matrix of claim 17, wherein the creatine protein matrix or the protein component establishes a pH of pH 7.0 to 8.0 in water.

27. The creatine protein matrix of claim 17, wherein the creatine protein matrix or the protein component establishes a pH of pH 7.1 to 7.8 in water.

28. The creatine protein matrix of claim 17, wherein the creatine protein matrix has a calorific value of from 700 to 1700 kJ/100 g.

29. A food supplement for athletes, comprising the creatine protein matrix of claim 17.

30. A method for producing a creatine protein matrix in powder form, comprising:
a) providing an aqueous, pasteurised solution or suspension Lq1 comprising at least one protein component selected from the group consisting of whey protein concentrates, whey protein isolates, whey protein hydrolysates and mixtures thereof, having a protein content in dry matter of at least 55 wt. %;
b) preparing a solution or suspension Lq2 by adding at least one creatine component selected from the group consisting of creatine or a salt thereof, creatine monohydrate or mixtures thereof, and optionally at least one mineral component selected from the group consisting of alkali or alkaline earth salts of phosphoric acid, diphosphoric acid, triphosphoric acid, citric acid, lactic acid, gluconic acid and mixtures thereof, simultaneously or in succession to the solution or suspension Lq1 provided; and,
c) drying the prepared solution or suspension Lq2 by means of spray drying, thin layer evaporation or roller drying methods.

31. The method of claim 30, wherein the solution or suspension Lq1 is lactose-free and/or comprises a whey protein concentrate, a whey protein isolate or a whey protein hydrolysate having a protein content of at least 55 wt. % (in dry substance).

32. The method of claim 30, wherein the solution or suspension Lq1 contains at least 30 wt. % dry matter.

33. The method of claim 30, wherein the solution Lq2, after addition of the creatine component and optionally the mineral component, is adjusted to a pH of pH 7.0 to 8.0 with a base.

34. The method of claim 30, wherein the solution Lq2, after addition of the creatine component and optionally the mineral component, is adjusted to a pH of pH 7.1 to 7.8 with a base.

35. An industrially produced creatine protein matrix in powder form comprising:
i) at least one protein component selected from the group consisting of whey protein concentrates, whey protein isolates, whey protein hydrolysates and mixtures thereof, having a protein content in dry matter of at least 55 wt. %; and,
ii) at least one creatine component selected from the group consisting of creatine, a salt thereof, creatine monohydrate and mixtures thereof,
wherein the creatine protein matrix is in the form of a powder having a mean particle size of from 10 to 250 μm and at least 50% of the powder contains particles wherein each individual particle comprises both the creatine component and the protein component, wherein the industrially produced creatine protein matrix in powder form is produced by the method of claim 30.
